(19) United States
(12) Patent Application Publication
(10) Pub. No.: US 2026/0168479 A1
(43) Pub. Date: Jun. 18, 2026

(54) FASTENING ARRANGEMENT AND WIND TURBINE

(71) Applicants: ZF FRIEDRICHSHAFEN AG, Friedrichshafen (DE); ZF Wind Power Antwerpen N.V., Lommel (BE)

(72) Inventors: Priyangu PATEL, Friedrichshafen (DE); Wim DE LAET, Antwerpen (BE)

(21) Appl. No.: 19/420,818

(22) Filed: Dec. 16, 2025

(30) Foreign Application Priority Data
Dec. 17, 2024 (DE) 102024212029.4

(51) Int. Cl. F03D 13/10; F03D 15/20; F03D 80/80

(52) U.S. Cl. CPC F03D 13/122; F03D 15/20; F03D 80/881

(57) ABSTRACT

A fastening arrangement for fastening a drive train to a wind turbine, the fastening arrangement including a housing in which at least one bearing for rotatably supporting a rotor shaft of the wind turbine is configured to be fastened and which is configured for fastening to a nacelle of the wind turbine. The housing is axially divided at least once and the housing includes a first piece and a second piece, which are fastened to one another.

### CROSS REFERENCE TO RELATED APPLICATIONS

This application claims benefit to German Patent Application No. DE 10 2024 212 029.4, filed on Dec. 17, 2024, which is hereby incorporated by reference herein.

### FIELD

The present invention relates to a fastening arrangement for a drive train of a wind turbine and to a wind turbine.

### BACKGROUND

Wind turbines are used to generate electricity from wind energy. For this purpose, wind turbines have a rotor. A rotational velocity of the rotor is transmitted to a gearbox by a rotor shaft. The rotational velocity of the rotor shaft is converted by the gearbox into a suitable rotational speed for driving a generator.

A drive train of the wind turbine, said drive train comprising at least the rotor shaft, must be supported on the rest of the wind turbine during operation. For example, the drive train is fastened to a nacelle of the wind turbine. However, this fastening can be very complex and can require many parts. Alternatively, fastening can also be accomplished solely by means of a single housing. However, this housing can then be so large and heavy that transport to the installation site of the wind turbine and mounting are possible only with great effort or are even no longer possible.

### SUMMARY

In an embodiment, the present disclosure provides a fastening arrangement for fastening a drive train to a wind turbine, the fastening arrangement comprising a housing in which at least one bearing for rotatably supporting a rotor shaft of the wind turbine is configured to be fastened and which is configured for fastening to a nacelle of the wind turbine. The housing is axially divided at least once and the housing comprises a first piece and a second piece, which are fastened to one another.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a wind turbine having a drive train;

FIG. 2 schematically illustrates, in a sectional view, a fastening arrangement for the drive train having a monolithic housing;

FIG. 3 schematically illustrates, in a side view, a first embodiment of the fastening arrangement having a multi-part housing, which is axially divided twice in an embodiment;

FIG. 4 schematically illustrates, in a sectional view, an embodiment of the fastening arrangement;

FIG. 5 schematically illustrates, in a sectional view, an embodiment of the fastening arrangement;

FIG. 6 schematically illustrates, in a sectional view, an embodiment of the fastening arrangement;

FIG. 7 schematically illustrates, in a sectional view, an embodiment of the fastening arrangement;

FIG. 8 schematically illustrates, in a sectional view, an embodiment of the fastening arrangement;

FIG. 9 schematically illustrates, in a sectional view, an embodiment of the fastening arrangement;

FIG. 10 schematically illustrates, in a sectional view, an embodiment of the fastening arrangement;

FIG. 11 schematically illustrates, in a sectional view, an embodiment of the fastening arrangement;

FIG. 12 schematically illustrates, in a sectional view, an embodiment of the fastening arrangement, in which the multi-part housing is axially divided only once;

FIG. 13 schematically illustrates, in a sectional view, an embodiment of the fastening arrangement, in which the multi-part housing is likewise axially divided only once;

FIG. 14 schematically illustrates, in a sectional view, an embodiment of the fastening arrangement;

FIG. 15 schematically illustrates, in a sectional view, an embodiment of the fastening arrangement;

FIG. 16 schematically illustrates, in a sectional view, details of an embodiment of the fastening arrangement;

FIG. 17 schematically illustrates, in a sectional view, an embodiment of the fastening arrangement;

FIG. 18 schematically illustrates, in a sectional view, an embodiment of the fastening arrangement;

FIG. 19 schematically illustrates, in a side view, an embodiment of an axially central piece of the housing which is axially divided twice;

FIG. 20 schematically illustrates, in a side view, an embodiment of an axially central piece of the housing which is axially divided twice;

FIG. 21 schematically illustrates, in a side view, an embodiment of an axially central piece of the housing which is axially divided twice; and

FIG. 22 schematically illustrates, in a side view, an embodiment of an axially central piece of the housing which is axially divided twice.

### DETAILED DESCRIPTION

A first aspect of the present disclosure relates to a fastening arrangement for fastening a drive train to a wind turbine. The wind turbine can comprise a tower and a nacelle arranged on the tower. The longitudinal extent of the tower extends, for example, in a vertical direction. The nacelle can, for example, be rotatably or non-rotatably mounted on the tower. The nacelle can be arranged, for example, on the top of the tower. The tower can, for example, be hollow. The tower can be tapered toward its upper end. The tower can also be cylindrical. The tower can have a round, oval or angular cross section. The tower can, for example, be formed of a plurality of tower elements stacked one on top of the other. The tower can comprise, for example, steel or alternatively or additionally concrete as a material.

The wind turbine can comprise, for example, a rotor, a gearbox and a generator. The rotor can drive the generator by means of the gearbox in order to generate electrical energy. The rotor is, for example, connected to the gearbox by means of a rotor shaft. The rotor, the gearbox and the generator can, for example, be fastened to a nacelle of the wind turbine, for example jointly by means of a main bearing system. The rotor can have a horizontal or a vertical axis of rotation. The rotor can comprise, for example, two, three, four or more rotor blades, which are connected to the rotor shaft by means of a hub. The drive train comprises at least the rotor shaft. The rotor shaft, the gearbox and the generator can, for example, be parts of the drive train. The drive train can optionally also comprise the rotor and, alternatively or additionally, the brake.

The fastening arrangement comprises a housing. At least one bearing for rotatably supporting the rotor shaft of the wind turbine can be fastenable in the housing. Two bearings for supporting the rotor shaft can also be arranged in the housing. If only one bearing is provided, the rotor shaft can be supported by means of an additional bearing in another component of the drive train, for example in a gearbox housing. If two bearings are provided in the housing for supporting the rotor shaft, the drive train can be free of additional bearings for the rotor shaft in other components of the drive train. The bearings can form part of the fastening arrangement or can be separate therefrom. The housing is designed for fastening to a nacelle of the wind turbine. The housing can have fastening interfaces for this purpose. The housing can be fastened to the nacelle, for example by means of a screwed connection to a machine bed. The bearings can be rolling-element bearings, for example. Suitable bearings are, for example, tapered roller bearings. Alternatively, the bearings can also be, for example, ball bearings, cylindrical roller bearings, toroidal bearings or plain bearings. The rotor shaft can thus be supported on the nacelle. The nacelle can comprise, for example, the machine bed to which the drive train is fastened. The housing and the one bearing and the optional second bearing in the housing can form a main bearing system of the drive train. The wind turbine can be free of additional bearings by means of which the drive train can be supported on the nacelle of the wind turbine. The main bearing system can be free of additional bearings. The rotor shaft can be supported on the nacelle solely by means of the main bearing system. The gearbox can, for example, likewise be supported on the nacelle solely by means of the main bearing system. Then, for example, stationary components of the housing, such as a gearbox housing, are fastened to the housing. At least one rotatable part, such as an input shaft of the gearbox, can be supported at the two bearings by means of the rotor shaft. Optionally, the generator can also be supported on the nacelle solely by means of the main bearing system, for example indirectly by means of the gearbox.

A first of the two bearings can be arranged axially in a rotor-side end region of the housing. The first bearing forms, for example, a rotor-side bearing. A second of the two bearings can be arranged axially in a generator-side end region of the housing. The second bearing forms, for example, a generator-side bearing. The two bearings can be axially spaced apart from one another. The two bearings can be arranged coaxially. In the axial region in which the two bearings are arranged, the housing can in each case be thickened and, alternatively or additionally, stiffened. The housing can have a closed peripheral ring region in the axial region in which each of the two bearings is arranged. The axial direction, a radial direction and a peripheral direction can be defined by the axis of rotation of the rotor shaft and alternatively or additionally by the axis of rotation of the particular bearings. An outer ring of each of the two bearings can be fastened in the housing with a clearance fit, a transition fit or a press fit, for example. An inner ring of each of the two bearings can be fastened to the rotor shaft with a clearance fit, a transition fit or a press fit, for example.

The housing is axially divided at least once. The housing can, for example, be axially divided once, twice or three times. The housing is thus of a multi-part design. The housing can thus have, for example, an axial cut which extends in a plane orthogonal to the axis of rotation of the rotor shaft. The housing can be a cast component or a forged part. The housing can have, for example, a cylindrical or conical basic shape.

The housing forms a first piece and a second piece, for example because of the axial division. The two pieces are fastened to one another. If more than two pieces are provided because of axial dividing more than once, two axially adjacent pieces can always be fastened to one another in a pair. Each piece can delimit an axial subregion of an interior of the housing. Each of the two pieces can be monolithic. Each piece can have an upper shell and a lower shell. The pieces can be connected to one another by means of fastening elements, for example by screws, rivets or bolts. The division can be axially at the center of the housing. The two pieces can be directly adjacent to one another and connected to one another. The two pieces can also be connected to one another indirectly, for example by means of an additional piece. The housing can be formed by exactly two pieces. The first piece and the second piece can form axial end pieces of the housing. The two pieces can be arranged in axially opposite end regions of the housing. The two pieces can have a cylindrical basic shape. The two pieces can be tapered in an axial direction, for example conically or in steps.

Because the housing is axially divided at least once, the housing can be easier to transport. For example, the two pieces can each be transported separately by means of a low loader. The two pieces can be designed to be fastened to one another only once they are at an installation site of the wind turbine. The two pieces can also be designed to be fastened to one another only once they are in the nacelle. Then mounting can be easy. Furthermore, production can also be easier. For example, two pieces can be cast more easily and more economically than a single-part housing. Thus, even very powerful wind turbines in difficult-to-access locations can be economically viable.

In an embodiment of the fastening arrangement, it can be provided that the drive train is held on the nacelle of the wind turbine exclusively by means of the housing. For example, it can be provided that no other component of the drive train, such as a gearbox housing or generator housing, is connected to the nacelle in a load-bearing way independently of the housing.

In an embodiment of the fastening arrangement, it can be provided that the housing is axially divided at least twice. The housing can additionally form a third piece. The first piece can be fastened to the second piece by means of the third piece. The housing can be divided exactly twice. The first and third pieces and the second and third pieces can be fastened to one another directly, for example without additional pieces arranged therebetween. For example, the housing can be axially divided into thirds. The first piece can be fastened to the third piece, for example on a rotor side of the third piece. The second piece can be fastened to the third piece, for example on a generator side of the third piece. The rotor side and the generator side can be axially opposite. The pieces can, for example, abut one another at end faces. The third piece can be arranged axially between the first and second pieces. The third piece can form an axial center piece and, alternatively or additionally, a connection piece. The third piece can have a cylindrical basic shape. The third piece can be tapered toward an end conically or in steps. The first bearing for the rotor shaft can be arranged in the first piece. The second bearing for the rotor shaft can be arranged in the second piece. The third piece can have no bearing arranged therein. Dividing twice allows highly compact transport. Furthermore, a modular construction can be enabled in which the pieces for receiving bearings and an axial length between the bearings can be flexibly designed. The housing can also be axially divided three or more times.

In an embodiment of the fastening arrangement, it can be provided that the third piece has at least one radial through-opening in its peripheral wall. The through-opening can form an access opening for mounting the pieces on one another, for example if the connecting of pieces is carried out within the housing. The radial through-opening can reduce the weight of the housing. Furthermore, maintenance can be made easier. The bearings can, for example, be axially sealed. A plurality of through-openings can also be provided. The through-opening can be designed according to the structural loading and the mounting requirements. The first piece and, alternatively or additionally, the second piece can be free of radial through-openings in their peripheral walls. As a result, these pieces can be very stiff and, for example, can absorb bearing loads well. Alternatively, the first piece and, alternatively or additionally, the second piece can likewise have at least one radial through-opening in their peripheral walls. As a result, these pieces can be very light and accessibility for mounting and maintenance in the housing can be improved.

In an embodiment of the fastening arrangement, it can be provided that at least one of the particular pieces is monolithic. A plurality or all of the pieces can also be monolithic. For example, the first, second and third pieces can each be a single cast part or a single forged part which has been integrally produced. The housing can thus be very robust.

In an embodiment of the fastening arrangement, it can be provided that, at least between two axially adjacent ones among the particular pieces, a dowel pin is provided. The dowel pin can be arranged, for example, between two contact faces of the two axially adjacent pieces. For example, the dowel pin can be arranged between two end faces abutting one another. For the dowel pin, a blind hole or through-hole in which the dowel pin is at least partly received can be provided in one of the two adjacent pieces. In the case of a through-hole, mounting and removal can be simple. In the case of a blind hole, the dowel pin can be held particularly securely. For the dowel pin, a blind hole or through-hole can likewise be provided in another of the two adjacent pieces. Alternatively, the dowel pin can be formed there integrally with the piece. However, the dowel pin can also be a part which is separate from the pieces. The dowel pin can have, for example, a round, angular or oval cross-sectional shape. A plurality of dowel pins spaced apart from one another in the peripheral direction can be provided. It can also be provided that at least one dowel pin is provided between each pair of axially adjacent pieces. If three pieces are provided, for example a plurality of dowel pins can be arranged between the first and third pieces and a plurality of dowel pins can be arranged between the second and third pieces. If two pieces are provided, for example a plurality of dowel pins can be arranged between the first and second pieces. The fastening arrangement can comprise the particular dowel pins. The dowel pins can, for example, be arranged between respective fastening elements in the peripheral direction. The dowel pins can, for example, make the mounting easier and can also improve force-fitting in the peripheral direction between the pieces.

In an embodiment of the fastening arrangement, it can be provided that two axially adjacent ones among the particular pieces form mutually corresponding contact sides with a shoulder for centering the two adjacent pieces with respect to one another. The contact faces can, for example, have end faces facing one another. One of the two adjacent pieces can then have an axial or transversely extending protrusion which is arranged in a corresponding axial recess of the other of the two pieces. However, the protrusion can also simply extend over an outer edge or inner edge of the other piece, without a corresponding recess being provided there. The shoulder can, for example, be in the form of a step. The shoulder and respective protrusions and recesses can extend along an entire periphery of the particular piece or only in some regions. Centering can help with coaxial orientation for mounting. The shoulder can also support one of the pieces for mounting. The shoulder can be arranged radially closer to an outer periphery than to an inner periphery of a peripheral wall. The shoulder can be arranged radially closer to an inner periphery than to an outer periphery of a peripheral wall. The shoulder can be arranged radially inside or radially outside relative to fastening elements and, alternatively or additionally, dowel pins between the two pieces. A plurality of shoulders can be provided on the two adjacent pieces. It can also be provided that, between each pair of axially adjacent pieces, at least one shoulder is provided on mutually corresponding contact sides. If three pieces are provided, for example, a shoulder can be formed on the contact faces of the first and third pieces and a shoulder can be formed on the contact faces of the second and third pieces. The shoulders and protrusions can be formed integrally on the respective pieces.

In an embodiment of the fastening arrangement, it can be provided that at least one of the particular pieces forms a radially protruding flange to which an adjacent piece is fastened. The flange can extend radially inward or outward. The flange can form a contact face for the adjacent piece, against which adjacent piece this piece can abut. The flange can have the shoulder. The flange can extend radially away from a peripheral wall of the particular piece and can be formed integrally with this wall. The flange can simplify the mounting and, for example, enable an otherwise thinner peripheral wall. The flange can, for example, form through-openings and, alternatively or additionally, blind holes for respective fastening elements and dowel pins. A corresponding radially protruding flange can be formed on the adjacent piece. It can also be provided that, for each pair of axially adjacent pieces, a radially protruding flange is formed on at least one piece of each pair of axially adjacent pieces, for the fastening of the other piece of each pair of axially adjacent pieces. The flange can be integrally formed on the particular piece. The flange can extend along an entire periphery of the particular piece or only in some regions. The flange can comprise the shoulder or can be arranged radially inside or outside relative thereto.

In an embodiment of the fastening arrangement, it can be provided that two axially adjacent ones among the particular pieces are fastened to one another by an associated fastening element. For example, the fastening element can be a screw, a bolt or a rivet. If the fastening element is a screw, this fastening element can be screwed in an internal screw thread or can be secured in a through-opening by a nut. On each of the two adjacent pieces, one through-opening, optionally having an internal screw thread, or one blind hole having an internal screw thread can be provided per fastening element. A plurality of fastening elements spaced apart from one another in the peripheral direction can be provided. It can also be provided that, for each pair of axially adjacent pieces, at least one fastening element is provided. If three pieces are provided, for example the first and third pieces can be fastened to one another by means of a plurality of fastening elements, and the second and third pieces can be fastened to one another by means of a plurality of fastening elements. If two pieces are provided, the first and second pieces can be fastened to one another by means of a plurality of fastening elements. The fastening arrangement can comprise the particular fastening elements. The fastening elements can, for example, be arranged between respective dowel pins in the peripheral direction. The fastening elements can alternatively or additionally also be arranged at a different radius than the dowel pins.

In an embodiment of the fastening arrangement, it can be provided that the fastening element extends parallel to the rotor shaft. For example, a longitudinal extent of a screw, a bolt or a rivet can be parallel to the axis of rotation of the rotor shaft. As a result, the fastening can, for example, withstand loads occurring during operation well. If a plurality of fastening elements connect two pieces, one or a plurality or all of these fastening elements can be oriented parallel to the rotor shaft. If three pieces are provided, only one or a plurality or all of the fastening elements between a pair of adjacent pieces, or of a plurality or all of the pairs of adjacent pieces, can extend parallel to the rotor shaft.

In an embodiment of the fastening arrangement, it can be provided that the fastening element extends at a radially inward or outward inclination with respect to the rotor shaft. As a result, the fastening element can be easy to access, for example for mounting or removal. For example, the longitudinal extent of the screw, the bolt or the rivet can be inclined with respect to the axis of rotation of the rotor shaft. The fastening element can extend in a plane with the rotor shaft or transversely thereto. If a plurality of fastening elements connect two pieces, one or a plurality or all of these fastening elements can be inclined radially with respect to the rotor shaft. If three pieces are provided, only one or a plurality or all of the fastening elements between a pair of adjacent pieces, or of a plurality or all of the pairs of adjacent pieces, can extend at a radial inclination with respect to the rotor shaft.

In an embodiment of the fastening arrangement, it can be provided that the fastening element is arranged on the housing such that the fastening element is accessible from the inside or from the outside. In the case of accessibility from the inside, for example a screwing knob is accessible within the housing for mounting and removal. For this purpose, an assembler can climb into the housing, a tool can be inserted axially or a radial through-opening in a peripheral wall of one of the pieces can be used. The nacelle can then be highly compact. In the case of accessibility from the outside, for example a screwing knob is accessible outside the housing for the mounting and removal. For example, a fastening element on a flange protruding radially outward can be accessible from the outside and a fastening element on a flange protruding radially inward can be accessible from the inside. It can be provided that all fastening elements are accessible either from the outside or from the inside. It can also be provided that some fastening elements are accessible from the inside and some fastening elements are accessible from the outside. For example, the fastening elements for fastening the first piece to the third piece can be accessible from the inside and the fastening elements for fastening the second piece to the third piece can be accessible from the outside.

In an embodiment of the fastening arrangement, it can be provided that the fastening arrangement comprises the drive train. In an embodiment of the fastening arrangement, it can be provided that at least two adjacent ones among the pieces are sealed. For example, an o-ring can be provided between respective contact faces. For example, a seal, such as a labyrinth seal or an o-ring, can be provided between the first piece and the third piece and between the second piece and the third piece. However, it can also be provided that only one seal is provided at the connection of the first or the second piece to the third piece.

A second aspect relates to a wind turbine which comprises the fastening arrangement according to the first aspect. Advantages and further features can be derived from the description of the first aspect, with embodiments of the first aspect also forming embodiments of the second aspect and vice versa. The wind turbine can comprise the tower, the nacelle and the drive train. The drive train can be fastened to the nacelle by means of the fastening arrangement.

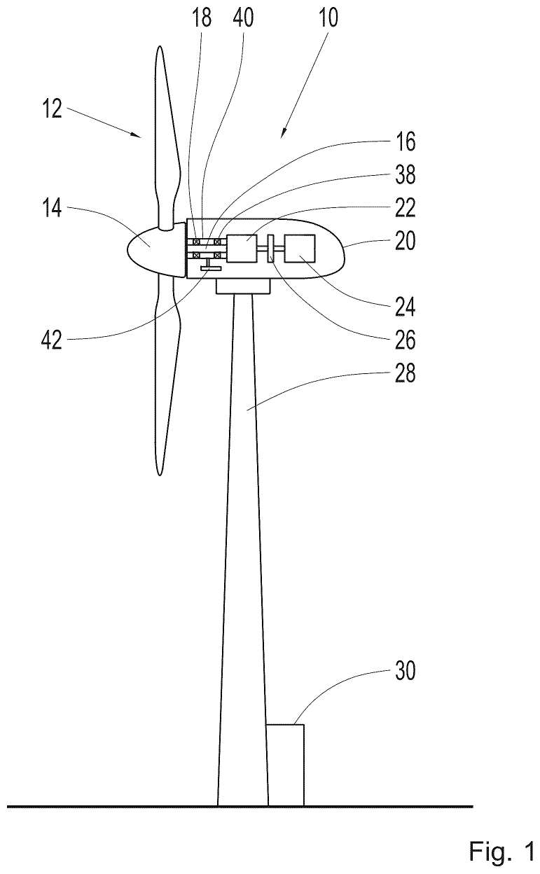

FIG. 1 illustrates a wind turbine 10 having a drive train in horizontal design. The wind turbine 10 comprises a rotor 12, which is held on a rotor shaft 16 by means of a hub 14. The axis of rotation of the rotor shaft 16 extends substantially horizontally. The rotor shaft 16 is supported in a nacelle 20 by means of two rolling-element bearings 18, 38. A housing 40 is provided therefor, the housing being fastened to a machine bed 42 of the nacelle 20. The rotor shaft 16 is operatively connected to a generator 24 mechanically by means of a gearbox 22. A brake 26 is also arranged in the operative connection between the gearbox 22 and the generator 24, said brake acting on an input shaft of the generator 24. The nacelle 20 is rotatably mounted on an upper end of a tower 28, which is anchored to the ground. In a further embodiment, the wind turbine 10 is in the form of an offshore turbine. In addition to the tower 28, the wind turbine 10 comprises a grid connection 30. A first of the rolling-element bearings 18 is closest to the rotor 12 and is also referred to as rotor-side bearing 18. A second of the rolling-element bearings 38 is closest to the generator 24 and is also referred to as generator-side bearing 38. The two rolling-element bearings 18, 38 are in the form of tapered roller bearings here.

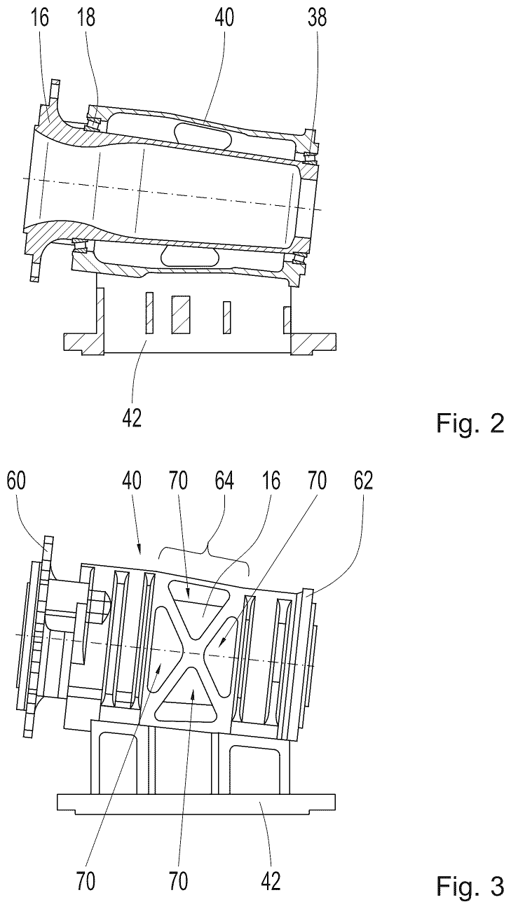

FIG. 2 illustrates a fastening arrangement for fastening the drive train to the machine bed 42 by means of the housing 40 in a sectional view. The housing 40 is monolithic here.

FIG. 3 illustrates a first embodiment of the fastening arrangement for fastening the drive train to the machine bed 42 by means of the housing 40 in a side view. Here, the housing 40 is axially divided twice. A first piece 60 forms a rotor-side end region of the housing 40 in which the first rolling-element bearing 18 is arranged. A second piece 62 forms a generator-side end region of the housing 40 in which the second rolling-element bearing 38 is arranged. A third piece 64 is arranged axially therebetween, the third piece forming a central piece by means of which the first and second pieces 60, 62 are connected to one another. In the third piece 64, the fastening arrangement is free of bearings for the rotor shaft 16. The third piece 64 has a multiplicity of radial through-openings 70 in its peripheral wall. The first and second pieces 60, 62 are free of radial through-openings 70 in their peripheral walls. The first piece 60 and the third piece 64 lie on one another at ends facing one another, as contact faces, and are fastened to one another there. The first piece 60 and the third piece 64 form a first pair of axially adjacent pieces 60, 64 of the housing 40. The second piece 62 and the third piece 64 lie on one another at ends facing one another, as contact faces, and are fastened to one another there. The second piece 62 and the third piece 64 form a second pair of axially adjacent pieces 64, 62 of the housing 40. The three pieces 60, 62, 64 are each monolithic.

The first piece 60 and the second piece 62 are fastened to one another by means of the third piece 64 by the use of fastening elements, in the form of screws, which are spaced apart from one another in the peripheral direction. Alternatively or additionally, dowel pins are provided between each pair of adjacent pieces 60, 64; 64, 62 of the housing 40. If provided, the dowel pins are arranged between fastening elements in the peripheral direction here. In the examples shown here, at least two dowel pins are provided per pair of adjacent pieces of the housing 40. Through-openings and blind holes are shown, in which the fastening elements and alternatively or additionally the dowel pins are received.

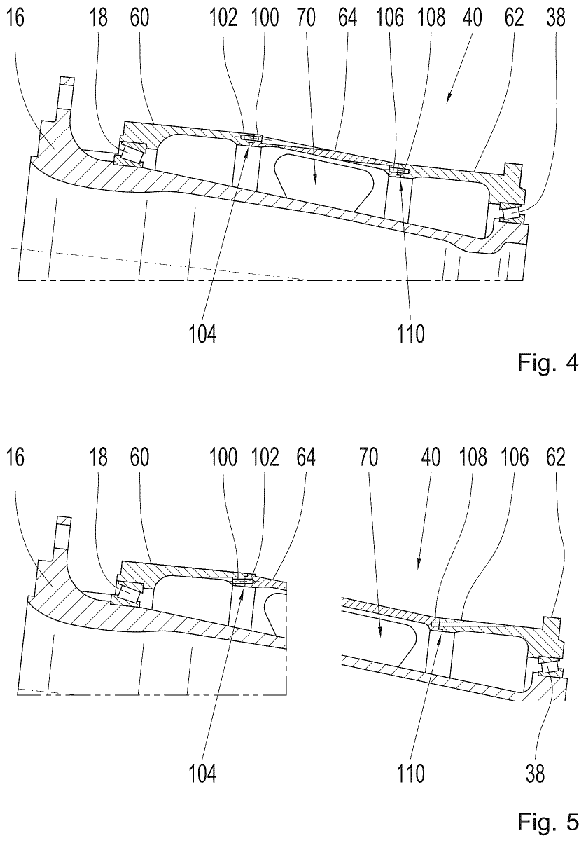

FIG. 4 shows further details of a second embodiment in a sectional view. The third piece 64 has, at the interface to the first piece 60, a plurality of through-openings 100 accessible from the outside. The first piece 60 has, at the interface to the third piece 64, a plurality of blind holes 102, which are aligned with the through-openings 100 in pairs. If a screw is arranged, as a fastening element, in respective blind holes 102, these blind holes 102 have an internal screw thread. At the contact faces of the first piece 60 and of the third piece 64, a shoulder 104 is provided on both sides, which centers the first and third pieces 60, 64 with respect to one another. The shoulder 104 is arranged radially inside relative to the through-openings 100 and the blind holes 102 and extends along an entire periphery.

The third piece 64 has, at the interface to the second piece 62, a plurality of through-openings 106 accessible from the inside. The second piece 62 has, at the interface to the third piece 64, a plurality of blind holes 108, which are aligned with the through-openings 106 in pairs. If a screw is arranged, as a fastening element, in respective blind holes 108, these blind holes 108 have an internal screw thread. At the contact faces of the second piece 62 and of the third piece 64, a shoulder 110 is provided on both sides, which centers the second and third pieces 62, 64 with respect to one another. The shoulder 110 is arranged radially inside relative to the through-openings 106 and the blind holes 108 and extends along an entire periphery.

FIG. 5 shows further details of a third embodiment in a sectional view. The third piece 64 has an axial central region. The interfaces between the pieces 60, 62, 64 are designed differently here.

The first piece 60 has, at the interface to the third piece 64, a plurality of through-openings 100 accessible from the inside. The third piece 64 has, at the interface to the first piece 60, a plurality of blind holes 102, which are aligned with the through-openings 100 in pairs. At the contact faces of the first piece 60 and of the third piece 64, a shoulder 104 is provided on both sides, which centers the first and third pieces 60, 64 with respect to one another. The shoulder 104 is arranged radially outside relative to the through-openings 100 and the blind holes 102.

The second piece 62 has, at the interface to the third piece 64, a plurality of through-openings 106 accessible from the outside. The third piece 64 has, at the interface to the second piece 62, a plurality of blind holes 108, which are aligned with the through-openings 106 in pairs. At the contact faces of the second piece 62 and of the third piece 64, a shoulder 110 is provided on both sides, which centers the second and third pieces 62, 64 with respect to one another. The shoulder 110 is arranged radially inside relative to the through-openings 106 and the blind holes 108.

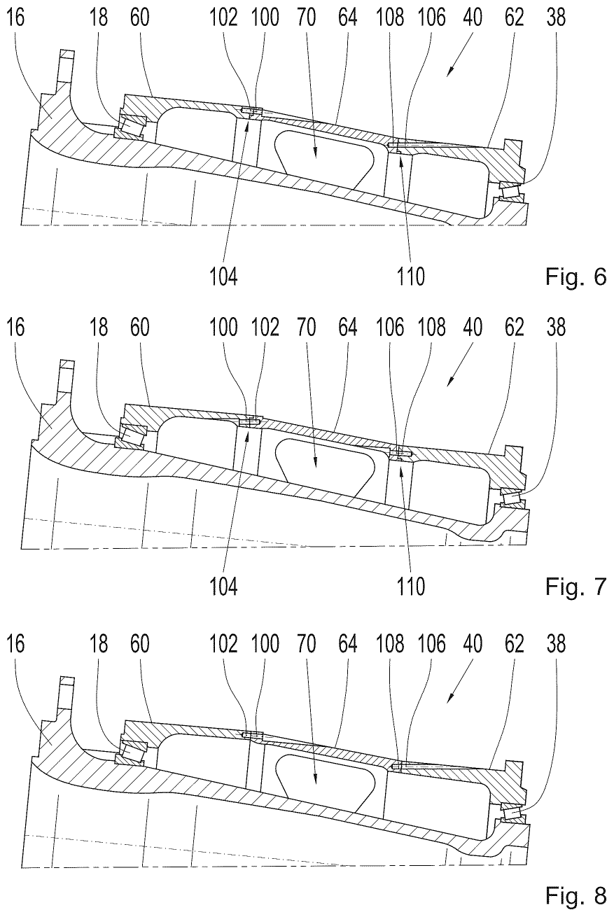

FIG. 6 shows further details of a fourth embodiment in a sectional view. The interfaces between the pieces 60, 62, 64 are likewise designed differently here. The interface between the first piece 60 and the third piece 64 is designed as in the first embodiment. The interface between the second piece 62 and the third piece 64 is designed as in the second embodiment.

FIG. 7 shows further details of a fifth embodiment in a sectional view. The interfaces between the pieces 60, 62, 64 are likewise designed differently here. The interface between the first piece 60 and the third piece 64 is designed as in the second embodiment. The interface between the second piece 62 and the third piece 64 is designed as in the first embodiment.

FIG. 8 shows further details of a sixth embodiment in a sectional view. The interfaces between the pieces 60, 62, 64 are likewise designed differently here. They are designed as in the fourth embodiment, but the shoulders 104, 110 are omitted. Instead, the contact faces extend purely radially as flat end faces here.

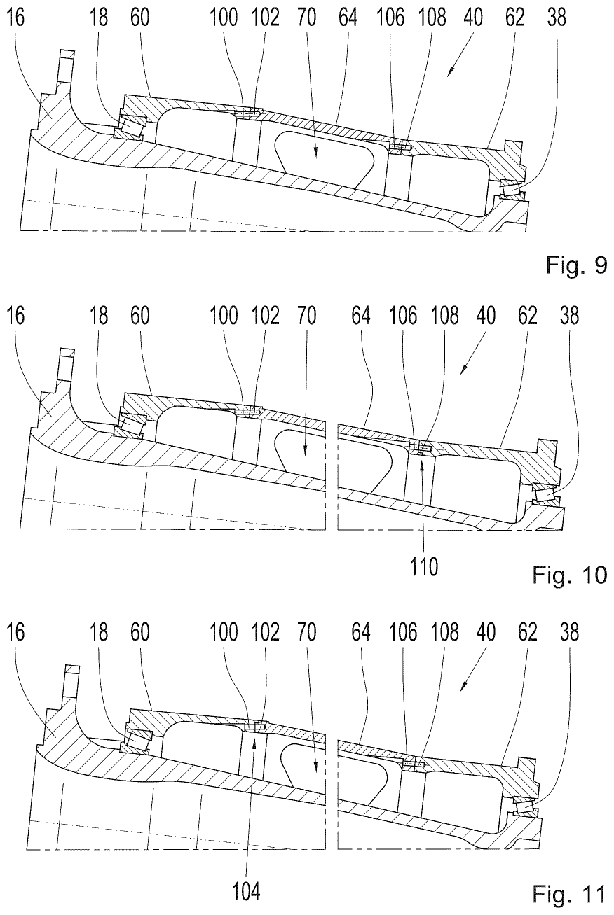

FIG. 9 shows further details of a seventh embodiment in a sectional view. The interfaces between the pieces 60, 62, 64 are likewise designed differently here. They are designed as in the fifth embodiment, but the shoulders 104, 110 are omitted. Instead, the contact faces extend purely radially as flat end faces here.

FIG. 10 shows further details of an eighth embodiment in a sectional view. The third piece 64 has an axial central region. The interfaces between the pieces 60, 62, 64 are likewise designed differently here. They are designed as in the fifth embodiment, but only the shoulder 104 between the first piece 60 and the third piece 64 is omitted. Instead, the contact face extends purely radially as flat end faces here.

FIG. 11 shows further details of a ninth embodiment in a sectional view. The third piece 64 has an axial central region. The interfaces between the pieces 60, 62, 64 are likewise designed differently here. They are designed as in the fifth embodiment, but only the shoulder 110 between the second piece 62 and the third piece 64 is omitted. Instead, the contact face extends purely radially as flat end faces here.

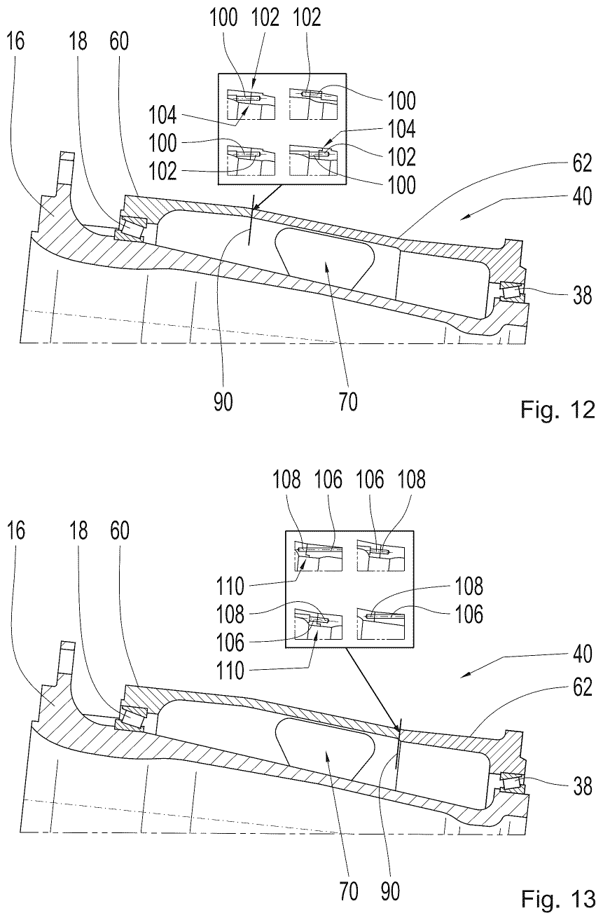

FIG. 12 shows a tenth embodiment of the fastening arrangement in which the housing 40 is axially divided only once. The dividing point and thus the interface between a first piece 60 and a second piece 62 is illustrated by line 90. The interface is located at the axial point at which the interface of the first piece 60 and the third piece 64 was in the preceding embodiments. The first piece 60 still forms the rotor-side end region, and the second piece 62 still forms the generator-side subregion. Both pieces 60, 62 are monolithic. The third piece 64 is omitted and is now part of the second piece 62. The second piece 62 accordingly now has the radial through-openings 70 in its peripheral wall. The interface between the first piece 60 and the second piece 62 is designed as in one of the preceding embodiments, as illustrated above the line 90.

FIG. 13 shows an eleventh embodiment of the fastening arrangement in which the housing 40 is likewise axially divided only once. The dividing point and thus the interface between a first piece 60 and a second piece 62 is illustrated by line 90. The interface is located at the axial point at which the interface of the second piece 62 and the third piece 64 was in the preceding embodiments. The first piece 60 still forms the rotor-side end region, and the second piece 62 still forms the generator-side subregion. Both pieces 60, 62 are monolithic. The third piece 64 is omitted and is now part of the first piece 60. The first piece 60 accordingly now has the radial through-openings 70 in its peripheral wall. The interface between the first piece 60 and the second piece 62 is designed as in one of the preceding embodiments, as illustrated above the line 90.

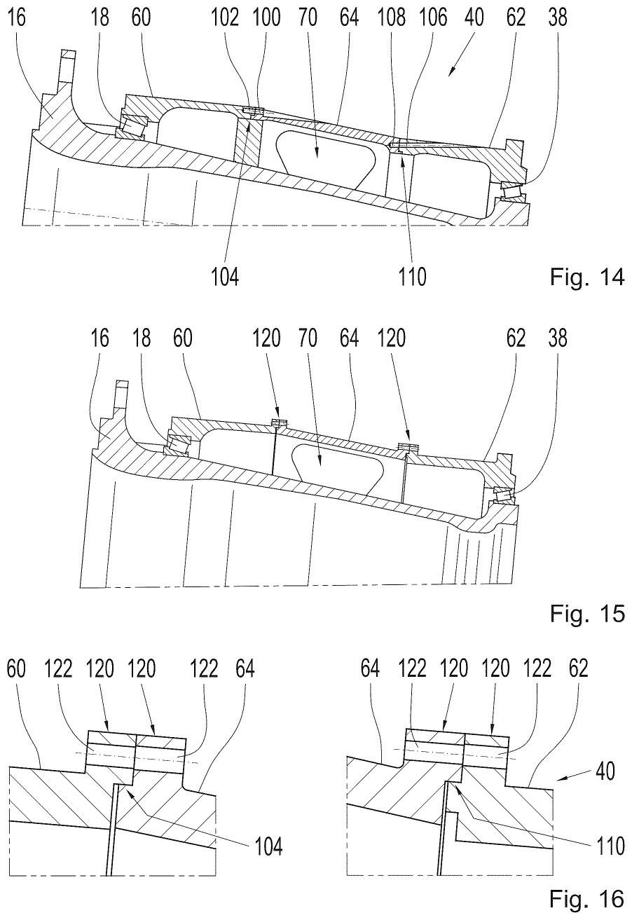

FIG. 14 shows, on the basis of a twelfth embodiment of the fastening arrangement, that the orientation of the through-openings 100, 106 and blind holes 102, 108 is parallel or inclined with respect to the rotor shaft 16. Accordingly, a parallel or inclined extent of the fastening elements also results. Merely for illustration, the interface between the first piece 60 and the third piece 64 is illustrated here for a parallel extent of the fastening elements with respect to an axis of rotation of the rotor shaft 16. Thus, respective longitudinal axes of the through-opening 100 and of the blind hole 102 also extend parallel to the axis of rotation of the rotor shaft 16. Merely for illustration, the interface between the second piece 62 and the third piece 64 is illustrated here for a radially inclined extent of the fastening elements with respect to an axis of rotation of the rotor shaft 16. Thus, respective longitudinal axes of the through-opening 106 and of the blind hole 108 extend in a plane with the axis of rotation of the rotor shaft 16 but transversely thereto. In other embodiments, the orientation of the two interfaces is exchanged or both interfaces are designed for a parallel or radially inclined orientation of the fastening elements.

FIG. 15 shows a thirteenth embodiment of the fastening arrangement in a sectional view, in which embodiment the housing 40 is again axially divided twice. The interfaces between the pieces 60, 62, 64 are likewise designed differently here. In the thirteenth embodiment, the pieces 60, 62, 64 each have, at the interfaces, a flange 120 extending away from the peripheral wall radially outward. In an embodiment, each flange 120 extends along an entire outer periphery. In other embodiments, the flange 120 extends only in the peripheral region of the fastening element respectively arranged therein and, alternatively or additionally, of the dowel pin respectively arranged therein.

FIG. 16 shows further details of the interfaces between the three pieces 60, 62, 64 in an enlarged view. On the left the interface between the first piece 60 and the third piece 64 is shown, and on the right the interface between the second piece 62 and the third piece 64 is shown. Each flange 120 forms an end abutment face for the adjacent one of the pieces 60, 62, 64. In each flange 120 at least one through-opening 122 is formed, which extends parallel to the rotor shaft 16 or at a radial inclination thereto in a plane. The through-openings 122 adjacent in pairs are arranged coaxially or in alignment. In an embodiment, screws are used as fastening elements, the screws engaging in a nut on the outside. Alternatively, one of the through-openings 122 of each pair of adjacent aligned through-openings 122 has an internal screw thread in which a screw, as fastening element, is screwed. Radially inside with respect to the through-openings 122, a shoulder 104 or shoulder 110 is formed in each case. In other embodiments, one or both of these shoulders 104, 110 is omitted. In still further embodiments, in the pairs of adjacent through-openings 122 one of the through-openings 122 is replaced by a blind hole 102, 108 having an internal screw thread.

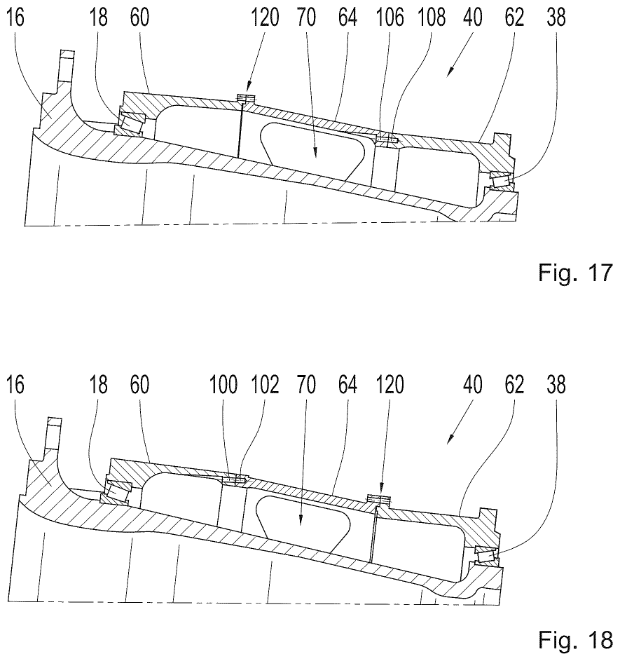

FIG. 17 shows a fourteenth embodiment of the fastening arrangement in a sectional view, the fourteenth embodiment being a modification of the thirteenth embodiment. In the fourteenth embodiment, flanges 120 are provided as in the thirteenth embodiment only at the interface between the first piece 60 and the third piece 64. The interface between the second piece 62 and the third piece 64 is designed as in the seventh embodiment in FIG. 9. In other embodiments, the interface between the second piece 62 and the third piece 64 is designed as in one of the other embodiments with the housing 40 axially divided twice and without a flange 120.

FIG. 18 shows a fifteenth embodiment of the fastening arrangement in a sectional view, the fifteenth embodiment being a modification of the thirteenth embodiment. In the fifteenth embodiment, flanges 120 are provided as in the thirteenth embodiment only at the interface between the second piece 62 and the third piece 64. The interface between the first piece 60 and the third piece 64 is designed as in the seventh embodiment in FIG. 9. In other embodiments, the interface between the second piece 62 and the third piece 64 is designed as in one of the other embodiments with the housing 40 axially divided twice and without a flange 120.

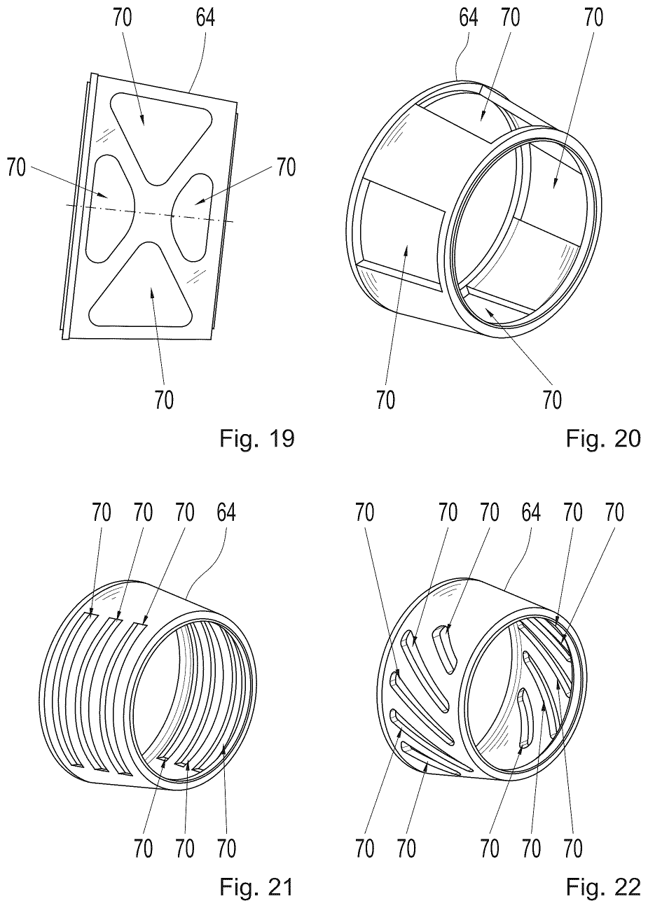

FIGS. 19 to 22 show various designs of the third piece 64 which are compatible with all embodiments of the housing 40 which are axially divided twice. FIG. 19 shows the design of the third piece 64 with four radial through-openings 70 on both sides in a horizontal extent next to the rotor shaft 16. The radial through-openings 70 are not uniformly shaped and have a triangular basic shape with rounded vertices. FIG. 20 shows a variant with four rectangular radial through-openings 70 which extend axially between the two interfaces with the other pieces 60, 62. FIG. 21 shows a variant in which, on both sides in a horizontal extent next to the rotor shaft 16, rectangular and slot-type radial through-openings 70 extending in the peripheral direction are arranged next to one another between the two interfaces with the other pieces 60, 62. At the top and the bottom, the housing 40 is solid. FIG. 22 shows a modification thereof in which the through-openings 70 are inclined and thus extend, with their longitudinal extent, both in the peripheral direction and in the axial direction.

In further embodiments of the housing 40 axially divided once, the radial through-openings 70 in the first piece 60 or in the second piece 62 are not shaped as in FIG. 13 or FIG. 12, but rather as in the third piece 64 according to one of the variants in FIGS. 20 to 22.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Wind Turbine
12 Rotor
14 Hub
16 Rotor Shaft
18 First Rolling-Element Bearing
20 Nacelle
22 Gearbox
24 Generator
26 Brake
28 Tower
30 Grid Connection
38 Second Rolling-Element Bearing
40 Housing
42 Machine Bed
60 First Piece
62 Second Piece
64 Third Piece
70 Radial Through-Openings
90 Line
100, 106, 122 Through-Opening
102, 108 Blind Hole
104, 110 Shoulder
120 Flange

1. A fastening arrangement for fastening a drive train to a wind turbine, the fastening arrangement comprising:
a housing in which at least one bearing for rotatably supporting a rotor shaft of the wind turbine is configured to be fastened and which is configured for fastening to a nacelle of the wind turbine,
wherein the housing is axially divided at least once and the housing comprises a first piece and a second piece, which are fastened to one another.

2. The fastening arrangement as claimed in claim 1, wherein the drive train is held on the nacelle of the wind turbine exclusively by the housing.

3. The fastening arrangement as claimed in claim 1, wherein the housing is axially divided at least twice and the housing additionally forms a third piece, by which the first piece is fastened to the second piece.

4. The fastening arrangement as claimed in claim 3, wherein the third piece has a peripheral wall and at least one radial through-opening in the peripheral wall.

5. The fastening arrangement as claimed in claim 3, wherein at least one of the first, second, and third pieces is monolithic.

6. The fastening arrangement as claimed in claim 3, wherein, at least between two axially adjacent pieces of the first, second, and third pieces, a dowel pin is provided.

7. The fastening arrangement as claimed in claim 3, wherein two axially adjacent pieces of the first, second, and third pieces form mutually corresponding contact sides having a shoulder for centering the two axially adjacent pieces with respect to one another.

8. The fastening arrangement as claimed in claim 3, wherein at least one of the first, second, and third pieces forms a radially protruding flange to which an adjacent piece of the first second, and third pieces is fastened.

9. The fastening arrangement as claimed in claim 3, wherein two axially adjacent pieces of the first, second, and third pieces are fastened to one another by an associated fastening element.

10. The fastening arrangement as claimed in claim 9, wherein the fastening element extends parallel to the rotor shaft.

11. The fastening arrangement as claimed in claim 9, wherein the fastening element extends at a radially inward or outward inclination with respect to the rotor shaft.

12. The fastening arrangement as claimed in claim 9, wherein the fastening element is arranged on the housing such that the fastening element is accessible from an inside or from an outside.

13. A wind turbine having the fastening arrangement as claimed in claim 1.
